(19) United States
(12) Patent Application Publication
(10) Pub. No.: US 2026/0292856 A1
(43) Pub. Date: Sep. 24, 2026

(54) METHOD OF BEAM DETERMINATION IN SIDELINK GROUPCAST COMMUNICATION, USER EQUIPMENT, AND CHIP

(71) Applicant: GUANGDONG OPPO MOBILE TELECOMMUNICATIONS CORP., LTD., Dongguan (CN)

(72) Inventor: Huei-Ming LIN, Taipei (TW)

(21) Appl. No.: 19/691,316

(22) Filed: May 28, 2026

Related U.S. Application Data
(63) Continuation of application No. PCT/CN2024/076596, filed on Feb. 7, 2024.

(51) Int. Cl. H04W 72/25; H04B 7/06; H04L 5/00

(52) U.S. Cl. CPC H04W 72/25; H04B 7/06952; H04L 5/0055

(57) ABSTRACT

A method of beam determination in sidelink groupcast communication (GC) by a user equipment (UE) includes performing a plurality of initial transmissions of a sidelink message transport block (TB) using a plurality of transmit beams in a plurality of time slots, respectively, wherein the plurality of initial transmissions of the sidelink message TB are associated with a plurality of physical sidelink feedback channel (PSFCH) occasions, respectively, and using a transmit beam selection based on at least one hybrid automatic repeat and request-acknowledgement (HARQ-ACK) report from at least one HARQ-ACK feedback UE and at least one of the plurality of PSFCH occasions.

### CROSS REFERENCE TO RELATED APPLICATION(S)

This application is a continuation of International Application No. PCT/CN2024/076596, filed Feb. 7, 2024, the entire disclosure of which is incorporated herein by reference.

### BACKGROUND OF DISCLOSURE

### 1. Field of the Disclosure

The present disclosure relates to the field of communication systems, and more particularly, to a method of beam determination in sidelink groupcast communication (GC), a user equipment (UE), and a chip, which can provide a good communication performance and/or provide high reliability.

### 2. Description of the Related Art

In the advancement of radio wireless transmission and reception directly between two devices, which is often known as device-to-device (D2D) communication, it is first developed by 3rd generation partnership project (3GPP) and introduced in Release 12 (officially specified as sidelink communication) and improved in Release 13 for public safety emergency usage such as mission critical communication to support mainly low data rate and voice type of connection. In 3GPP Releases 14, 15, and 16, the sidelink technology is advanced to additionally support vehicle-to-everything (V2X) communication as part of global development of intelligent transportation system (ITS) to boost road safety and advanced/autonomous driving use cases. To further expand the support of sidelink technology to wider applications and devices with limited power supply/battery, the technology is further enhanced in Release 17 in the area of device power saving and transceiver link reliability. For Release 18, 3GPP is currently looking to evolve the wireless technology and expand its operation into unlicensed frequency spectrum for larger available bandwidth, faster data transfer rate, and easier market adoption of D2D communication using sidelink without requiring any mobile cellular operator's involvement to allocate and configure a part of their expansive precious radio spectrum for data services that do not go through their mobile networks.

For the NR sidelink system, it is claimed to support frequency range 2 (FR2) spectrum bands (24250 MHz-71000 MHz) by introducing a phase tracking reference signal (PT-RS) in Release 16. However, no particular enhancement or feature has been supported in NR sidelink to combat/mitigate the high pathloss issue in FR2.

Therefore, there is a need for a user equipment (UE) and a method of beam determination in sidelink groupcast communication (GC), which can solve issues in the prior art and other issues.

### SUMMARY

In a first aspect of the present disclosure, a method of beam determination in sidelink groupcast communication (GC) by a user equipment (UE) includes performing a plurality of initial transmissions of a sidelink message transport block (TB) using a plurality of transmit beams in a plurality of time slots, respectively, wherein the plurality of initial transmissions of the sidelink message TB are associated with a plurality of physical sidelink feedback channel (PSFCH) occasions, respectively, and using a transmit beam selection based on at least one hybrid automatic repeat and request-acknowledgement (HARQ-ACK) report from at least one HARQ-ACK feedback UE and at least one of the plurality of PSFCH occasions.

In a second aspect of the present disclosure, a user equipment (UE) includes a memory, a transceiver, and a processor coupled to the memory and the transceiver. The UE is configured to perform the above method.

In a third aspect of the present disclosure, a chip includes a processor, configured to call and run a computer program stored in a memory, to cause a device in which the chip is installed to execute the above method.

### BRIEF DESCRIPTION OF DRAWINGS

In order to illustrate the embodiments of the present disclosure or related art more clearly, the following figures that will be described in the embodiments are briefly introduced. It is obvious that the drawings are merely some embodiments of the present disclosure, a person having ordinary skill in this field can obtain other figures according to these figures without paying the premise.

FIG. 1 is a block diagram of user equipments (UEs) of communication in a communication network system according to an embodiment of the present disclosure.

FIG. 2 is a schematic diagram illustrating a user plane protocol stack according to an embodiment of the present disclosure.

FIG. 3 is a schematic diagram illustrating a control plane protocol stack according to an embodiment of the present disclosure.

FIG. 4 is a flowchart illustrating a method of beam determination in sidelink groupcast communication (GC) according to an embodiment of the present disclosure.

FIG. 5 is a schematic diagram illustrating a proposed method of transmit (TX) beam selection in sidelink groupcast communication with acknowledgement (ACK)/negative-acknowledgement (NACK) feedback according to an embodiment of the present disclosure.

FIG. 6 is a schematic diagram illustrating a proposed method of TX beam selection in sidelink groupcast communication with NACK-only feedback according to an embodiment of the present disclosure.

FIG. 7 is a block diagram of a UE for wireless communication according to an embodiment of the present disclosure.

FIG. 8 is a block diagram of an example of a computing device according to an embodiment of the present disclosure.

FIG. 9 is a block diagram of a system for wireless communication according to an embodiment of the present disclosure.

### DETAILED DESCRIPTION OF EMBODIMENTS

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

Since 3GPP Release 16, the sidelink technology has been developed based on the latest 5th generation (5G) new radio (NR) access system including the support of frequency range 1 (FR1) bands (410 MHz-7125 MHz), frequency range 2 (FR2) bands (24250 MHz-71000 MHz) and various orthogonal frequency division multiplexing signal (OFDM) transmission numerologies/sub-carrier spacings (SCSs) (15 k, 30 k, 60 k and 120 k Hz). One of the main motivations to support additional spectrum bands compared to the 4G long term evolution (LTE) system (i.e., FR2) is the availability of large spectral bandwidth to support high data rate applications and various SCSs to allow very low latency radio transmissions for delay sensitive services. However, main drawbacks of using high frequency bands (i.e., in FR2) for radio transmission are the high attenuation of signal strength over distance from the transmitter (high pathloss) and the system is prone to frequency/phase errors due to the short wavelengths. For the NR sidelink system, it is claimed to support FR2 spectrum bands by introducing a phase tracking reference signal (PT-RS) in Release 16. However, no particular enhancement or feature has been supported in NR sidelink to combat/mitigate the high pathloss issue in FR2.

### Transmit Beamforming and Sweeping in Downlink

Over downlink (DL) and uplink (UL) of Uu interface, the concept/feature of transmit beamforming and beam management is developed and introduced since the beginning of the 5G-NR system in Release 15 to improve received signal strength, enhance cellular DL and UL coverages and minimize radio interference to neighbor cells. In order to enable the transmit beamforming/beam management feature over the Uu interface, particularly in the DL, the concept of beam sweeping is introduced by forming a transmit beam and sweeping the transmit beam across all the directions in space (both horizontal and vertical spatial domains) that a base station (gNB) supports. Once a user equipment (UE) has received all the transmit beams or as many as it could (according to a pre-defined pattern and time interval), the UE selects a best beam and sends a physical random-access channel (PRACH) to the gNB in a random-access channel (RACH) occasion that corresponds to the selected best beam. At the base station, the gNB determines the selected best beam from the UE according to the received RACH occasion and uses the selected best beam to complete the random-access procedure in order for the UE to connect to the base station. The same best beam may be also used for subsequent data communication between the gNB and the UE until the beam is further updated/switched.

### Necessity of Transmit Beamforming and Beam Management in Sidelink

As mentioned previously, radio communication in high frequency spectrum (i.e., FR2 bands) may suffer from large attenuation in transmitted signals and propagation loss through the space compared to lower frequency bands that a cellular system traditionally operates. Besides PT-RS that can be used by sidelink communicating devices to correct phase errors in the received carrier frequency in FR2 and the maximum device transmit power is limited by a device's power class definition, there is currently no other way to improve a communication range/signal coverage but to also support transmit beamforming and beam management for the NR sidelink technology. By improving the signal coverage/communication range for sidelink, it enables a few new use cases and applications for the users, such as enhancing the network coverage from SL relaying on a FR2 carrier and offloading network traffic onto a sidelink FR2 carrier for two UEs that are within the same cell.

### Sidelink Hybrid Automatic Repeat and Request (HARQ) Feedback for Groupcast and Unicast Communication

In order to support more advanced applications and use cases using the NR SL technology, such as vehicle platooning, autonomous driving in V2X and high data rate augmented reality (AR)/virtual reality (VR) in commercial applications, the feature of sidelink HARQ feedback for reporting of an acknowledgement (ACK) or negative-acknowledgement (NACK) from a reception UE (Rx-UE) to determine a subsequent retransmission of the same data transport block (TB) from a Tx-UE is introduced in 3GPP Release 16 for sidelink groupcast (GC) and unicast (UC) communications.

In sidelink GC communication, two types of SL-HARQ feedback reporting mechanisms are supported, namely “groupcast option 1” and “groupcast option 2”. In “groupcast option 1”, only a NACK report is fed back in a physical sidelink feedback channel (PSFCH) using a common PSFCH resource from a Rx-UE when a received physical sidelink control channel (PSCCH) and its associated physical sidelink shared channel (PSSCH) are not decoded successfully. That is, an ACK is not reported at all even when the sidelink message transport block (TB) carried in PSCCH/PSSCH is successfully decoded by the Rx-UE. This type of SL-HARQ feedback operation is intended for a connectionless groupcast communication based on a communication distance range, where the number of intended Rx-UEs within the distance range is unknown to the Tx-UE. In “groupcast option 2”, both ACK and NACK feedback reporting from a Rx-UE are supported for connection-oriented groupcast communication, where the total number of UE members in a same group is known to all UEs.

In sidelink UC communication, similar to groupcast option 2, both ACK and NACK feedback reporting from a Rx-UE are supported.

In some embodiments, in the present proposed beam management scheme for sidelink (SL) groupcast communication, a set of one or more transmit (TX) beams to be used for transmission or retransmission of a SL message transport block (TB) to improve SL communication performance is determined and selected based on SL-HARQ acknowledgement (ACK) and/or negative-acknowledgement (NACK) feedback(s) and feedback occasion(s) used for the SL-HARQ reporting from sidelink receiver UEs such that SL resource usage is minimized from not always performing beam sweeping in all directions to deliver data information. Other benefits from adopting the proposed HARQ-based beamforming and beam management methods for SL communication may also include at least one of followings: 1. Minimization the amount of sweeping of transmit beams for a TX-UE in a sidelink groupcast communication, which will subsequently reduce the amount of SL resources and RX-UE processing time and decoding effort. 2. Consequently, the proposed TX beam selection methods provide better and targeted selection of TX beam(s) towards intended receiver UE(s) that really requires a retransmission(s) of a SL message delivery. 3. Existing HARQ-ACK feedback control signaling is reused for TX beam(s) selection without requiring a new feedback/reporting signaling mechanism. 4. Further SL resource savings by eliminating the use of PSCCH and PSSCH for beam management and reporting. And hence, achieving a reduction in the overall sidelink traffic load and minimizing a half-duplex problem from performing less transmissions while supporting the beamforming and beam management feature to enhance the SL communication. 5. Achieve a fast indication and determination of transmit beams from all Rx-UEs by reusing the existing and immediate SL-HARQ feedback signaling mechanism.

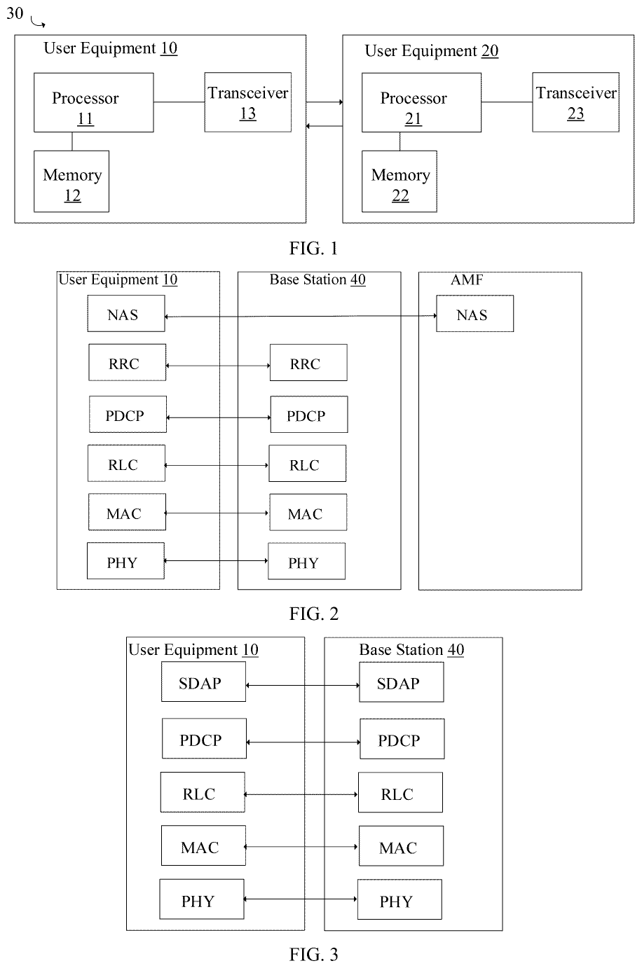

FIG. 1 illustrates that, in some embodiments, one or more user equipments (UEs) 10 (such as a first UE) and one or more user equipments (UEs) 20 (such as a second UE) of communication in a communication network system 30 according to an embodiment of the present disclosure are provided. The communication network system 30 includes one or more UEs 10 and one or more UE 20. The UE 10 may include a memory 12, a transceiver 13, and a processor 11 coupled to the memory 12 and the transceiver 13. The UE 20 may include a memory 22, a transceiver 23, and a processor 21 coupled to the memory 22 and the transceiver 23. The processor 11 or 21 may be configured to implement proposed functions, procedures and/or methods described in this description. Layers of radio interface protocol may be implemented in the processor 11 or 21. The memory 12 or 22 is operatively coupled with the processor 11 or 21 and stores a variety of information to operate the processor 11 or 21. The transceiver 13 or 23 is operatively coupled with the processor 11 or 21 and transmits and/or receives a radio signal.

The processor 11 or 21 may include application-specific integrated circuit (ASIC), other chipset, logic circuit and/or data processing device. The memory 12 or 22 may include read-only memory (ROM), random access memory (RAM), flash memory, memory card, storage medium and/or other storage device. The transceiver 13 or 23 may include baseband circuitry to process radio frequency signals. When the embodiments are implemented in software, the techniques described herein can be implemented with modules (e.g., procedures, functions, and so on) that perform the functions described herein. The modules can be stored in the memory 12 or 22 and executed by the processor 11 or 21. The memory 12 or 22 can be implemented within the processor 11 or 21 or external to the processor 11 or 21 in which case those can be communicatively coupled to the processor 11 or 21 via various means as is known in the art.

The communication between UEs relates to vehicle-to-everything (V2X) communication including vehicle-to-vehicle (V2V), vehicle-to-pedestrian (V2P), and vehicle-to-infrastructure/network (V2I/N) according to a sidelink technology developed under 3rd generation partnership project (3GPP) long term evolution (LTE) and new radio (NR) releases 17, 18 and beyond. UEs are communicated with each other directly via a sidelink interface such as a PC5 interface. Some embodiments of the present disclosure relate to sidelink communication technology in 3GPP NR releases 19 and beyond, for example providing cellular-vehicle to everything (C-V2X) communication.

In some embodiments, the UE 10 may be a sidelink packet transport block (TB) transmission UE (Tx-UE). The UE 20 may be a sidelink packet TB reception UE (Rx-UE) or a peer UE. The sidelink packet TB Rx-UE can be configured to send ACK/NACK feedback to the packet TB Tx-UE. The peer UE 20 is another UE communicating with the Tx-UE 10 in a same SL unicast or groupcast session.

FIG. 2 illustrates an example user plane protocol stack according to an embodiment of the present disclosure. FIG. 2 illustrates that, in some embodiments, in the user plane protocol stack, where service data adaptation protocol (SDAP), packet data convergence protocol (PDCP), radio link control (RLC), and media access control (MAC) sublayers and physical (PHY) layer (also referred as first layer or layer 1 (L1) layer) may be terminated in a UE 10 and a base station 40 (such as gNB) on a network side. In an example, a PHY layer provides transport services to higher layers (e.g., MAC, RRC, etc.). In an example, services and functions of a MAC sublayer may comprise mapping between logical channels and transport channels, multiplexing/demultiplexing of MAC service data units (SDUs) belonging to one or different logical channels into/from transport blocks (TBs) delivered to/from the PHY layer, scheduling information reporting, error correction through hybrid automatic repeat request (HARQ) (e.g. one HARQ entity per carrier in case of carrier aggregation (CA)), priority handling between UEs by means of dynamic scheduling, priority handling between logical channels of one UE by means of logical channel prioritization, and/or padding. A MAC entity may support one or multiple numerologies and/or transmission timings. In an example, mapping restrictions in a logical channel prioritization may control which numerology and/or transmission timing a logical channel may use. In an example, an RLC sublayer may supports transparent mode (TM), unacknowledged mode (UM) and acknowledged mode (AM) transmission modes. The RLC configuration may be per logical channel with no dependency on numerologies and/or transmission time interval (TTI) durations. In an example, automatic repeat request (ARQ) may operate on any of the numerologies and/or TTI durations the logical channel is configured with. In an example, services and functions of the PDCP layer for the user plane may comprise sequence numbering, header compression, and decompression, transfer of user data, reordering and duplicate detection, PDCP PDU routing (e.g., in case of split bearers), retransmission of PDCP SDUs, ciphering, deciphering and integrity protection, PDCP SDU discard, PDCP re-establishment and data recovery for RLC AM, and/or duplication of PDCP PDUs. In an example, services and functions of SDAP may comprise mapping between a QoS flow and a data radio bearer. In an example, services and functions of SDAP may comprise mapping quality of service Indicator (QFI) in downlink (DL) and uplink (UL) packets. In an example, a protocol entity of SDAP may be configured for an individual PDU session.

FIG. 3 illustrates an example control plane protocol stack according to an embodiment of the present disclosure. FIG. 3 illustrates that, in some embodiments, in the control plane protocol stack where PDCP, RLC, and MAC layers and PHY layer may be terminated in a UE 10 and a base station 40 (such as gNB) on a network side and perform service and functions described above. In an example, radio resource control (RRC) used to control a radio resource between the UE and a base station (such as a gNB). In an example, RRC may be terminated in a UE and the gNB on a network side. In an example, services and functions of RRC may comprise broadcast of system information related to access stratum (AS) and non-access stratum (NAS), paging initiated by 5G core network (5GC) or radio access network (RAN), establishment, maintenance and release of an RRC connection between the UE and RAN, security functions including key management, establishment, configuration, maintenance and release of signaling radio bearers (SRBs) and data radio bearers (DRBs), mobility functions, QoS management functions, UE measurement reporting and control of the reporting, detection of and recovery from radio link failure, and/or non-access stratum (NAS) message transfer to/from NAS from/to a UE. In an example, NAS control protocol may be terminated in the UE and AMF on a network side and may perform functions such as authentication, mobility management between a UE and an access and mobility management function (AMF) for 3GPP access and non-3GPP access, and session management between a UE and a SMF for 3GPP access and non-3GPP access.

When a specific application is executed and a data communication service is required by the specific application in the UE, an application layer taking charge of executing the specific application provides the application-related information, that is, the application group/category/priority information/ID to the NAS layer. In this case, the application-related information may be pre-configured/defined in the UE. Alternatively, the application-related information is received from the network to be provided from the AS (RRC) layer to the application layer, and when the application layer starts the data communication service, the application layer requests the information provision to the AS (RRC) layer to receive the information.

In some embodiments, the transceiver 13 is configured to perform a plurality of initial transmissions of a sidelink message transport block (TB) using a plurality of transmit beams in a plurality of time slots, respectively, wherein the plurality of initial transmissions of the sidelink message TB are associated with a plurality of physical sidelink feedback channel (PSFCH) occasions, respectively. The processor 11 is configured to use a transmit beam selection based on at least one hybrid automatic repeat and request-acknowledgement (HARQ-ACK) report from at least one HARQ-ACK feedback UE and at least one of the plurality of PSFCH occasions. This can solve issues in the prior art and other issues and/or improve SL communication performance and reliability.

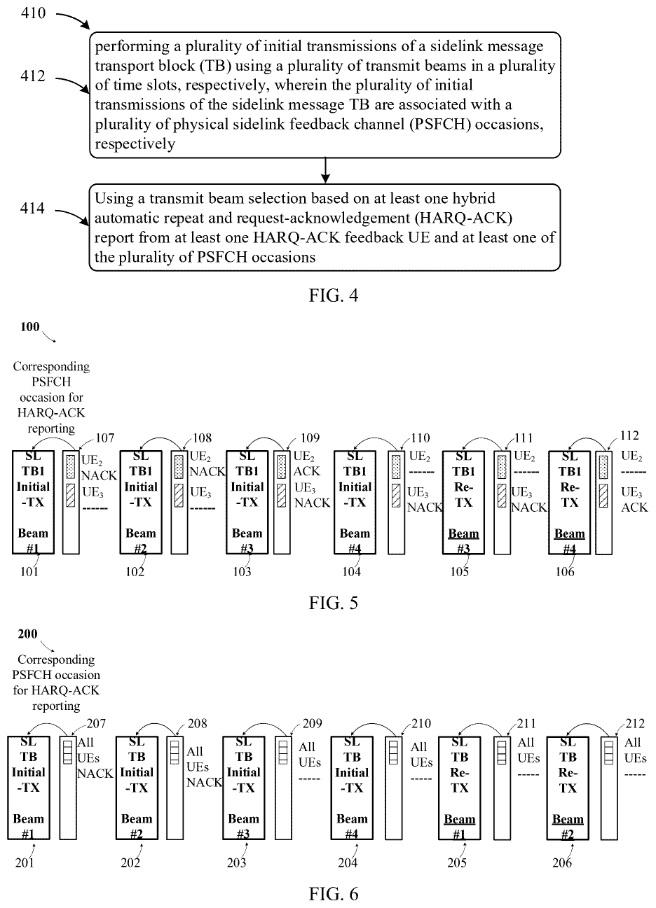

FIG. 4 illustrates a method 410 of beam determination in sidelink groupcast communication (GC) between user equipments (UEs) according to an embodiment of the present disclosure. In some embodiments, the method 410 includes: an operation 412, performing a plurality of initial transmissions of a sidelink message transport block (TB) using a plurality of transmit beams in a plurality of time slots, respectively, wherein the plurality of initial transmissions of the sidelink message TB are associated with a plurality of physical sidelink feedback channel (PSFCH) occasions, respectively, and an operation 414, using a transmit beam selection based on at least one hybrid automatic repeat and request-acknowledgement (HARQ-ACK) report from at least one HARQ-ACK feedback UE and at least one of the plurality of PSFCH occasions. This can solve issues in the prior art and other issues and/or improve SL communication performance and reliability.

In some embodiments, the plurality of initial transmissions of the sidelink message TB are performed in physical sidelink control channels (PSCCHs) and/or physical sidelink shared channels (PSSCHs). In some embodiments, the transmit beam selection includes determining whether to perform at least one retransmission of the sidelink message TB and determining at least one of the transmit beams for the at least one retransmission of the sidelink message TB based on the at least one HARQ-ACK report from the at least one HARQ-ACK feedback UE and the at least one PSFCH occasion. In some embodiments, no retransmission of the sidelink message TB is performed by the UE if at least one ACK of the at least one HARQ-ACK report is received from the at least one HARQ-ACK feedback UE.

In some embodiments, if the UE does not receive at least one ACK of the at least one HARQ-ACK report from the at least one HARQ-ACK feedback UE, the at least one retransmission of the sidelink message TB is performed by the UE using the at least one transmit beam corresponding to at least one NACK of the at least one HARQ-ACK report received from the at least one HARQ-ACK feedback UE. In some embodiments, the at least one retransmission of the sidelink message TB is performed by the UE using the at least one transmit beam corresponding to at least one NACK of the at least one HARQ-ACK report received from the at least one HARQ-ACK feedback UE until no NACK is received or a maximum number of retransmissions for the sidelink message TB is reached.

In some embodiments, the term “/” can be interpreted to indicate “and/or.” The term “configured” can refer to “pre-configured” and “network configured”. The term “pre-defined” or “pre-defined rules” in the present disclosure may be achieved by pre-storing corresponding codes, tables, or other manners for indicating relevant information in devices (e.g., including a UE and a network device). The specific implementation is not limited in the present disclosure. For example, “pre-defined” may refer to those defined in a protocol. It is also to be understood that in the disclosure, “protocol” may refer to a standard protocol in the field of communication, which may include, for example, an LTE protocol, NR protocol and relevant protocol applied in the future communication system, which is not limited in the present disclosure.

### EXAMPLES

For the present disclosure of new inventive and simple transmit (TX) beam selection methods in sidelink (SL) groupcast communication, it is proposed that a TX user equipment (TX-UE) selects one or more TX beam(s) for a transmission or retransmission of a SL message transport block (TB) based on hybrid automatic repeat and request-acknowledgement (HARQ-ACK) feedback information received in physical sidelink feedback channel (PSFCH). More specifically, the selection of TX beam(s) is in accordance with PSFCH occasion(s) in which a negative acknowledgement (NACK) response is received for the transmitted SL message TB.

In sidelink groupcast communication, unlike the SL unicast communication, certain features are not supported and they are commonly used for beam management in DL and UL unicast communication over the Uu interface, such as 1. Channel state information-reference signal (CSI-RS) that is needed for measurement of the communication channel in order for the receiver node of a unicast link to determine a best TX beam for the wireless communication between the transmitter and the receiver. 2. A dedicated radio resource control (RRC) signaling connection to exchange beam selection and beam management information between the communication nodes in a unicast link.

Without the above features being supported in SL groupcast communication, it is uncertain how to support a selection of best TX beams that should be used by a SL transmitting UE in SL groupcast communication to improve communication performance.

### Proposed Transmit Beamforming and Beam Selection Methods for SL Groupcast Communication

In order for a SL transmitter UE to determine and select appropriate TX beam(s) for delivering a message transport block (TB) to receiver UEs within a SL groupcast communication without the traditional CSI-RS transmission, measurement and beam index reporting from the receiver UEs, it is proposed to adopt a TX beam selection approach based on feedback information carried in PSFCH from the target groupcast receiver UEs.

The main principle of the proposed TX beam selection for transmitting a message TB in SL groupcast communication relies on HARQ-ACK reporting information from groupcast receiver UEs and performs retransmission(s) of the message TB in a beam direction(s) where the corresponding NACK(s) is received. Consequently, the proposed TX beam selection methods provide better and targeted selection of TX beam(s) towards intended receiver UE(s) that really requires a retransmission(s) of a SL message delivery.

### Example Method 1 (Minimization of TX Beam Sweeping Based on ACK/NACK Feedbacks)

In some embodiments, in SL groupcast communication, when SL HARQ-ACK reporting is enabled and groupcast Option 2 is indicated by the SL transmitting UE (TX-UE) in SCI for a transmitted message TB, each intended target receiver UE (RX-UE) of the transmission (i.e., every member UE within the groupcast communication) is required to send its decoding result of the message TB received by the RX-UE (ACK or NACK report) to the TX-UE via a dedicated PSFCH resource in a PSFCH occasion associated to the SL transmission.

In some embodiments, for an initial delivery of a SL transport block (TB) in SL groupcast communication, the TX-UE performs multiple transmissions of the same TB (i.e., using a same HARQ redundancy version but in different time slots) using a set of TX beams supported by the TX-UE (e.g., in different beam directions by sweeping across the set of supported TX beams). In some examples, for the groupcast Option 2 HARQ-ACK feedback scheme (ACK and NACK), each of the multiple transmissions of the same TB and for each of the member UEs in the groupcast, an individual HARQ-ACK feedback resource (cyclic shift pair) is mapped in a PSFCH occasion/symbol. As such, the HARQ-ACK feedback (ACK/NACK) from each of the member UEs can be clearly identified by the TX-UE.

In some embodiments, for each of the multiple transmissions of the same TB, a RX-UE (e.g., a GC member UE) feeds back an ACK for a successfully decoded TB or a NACK for a decoding failure. In some examples, based on the PSFCH occasion and PSFCH resource used for HARQ-ACK feedback from the RX-UE, the TX-UE would be able to determine the best TX beam(s) for the RX-UE (a member UE). And the TX-UE performs the same for all other RX-UEs (member UEs) based on their HARQ-ACK feedback reports.

In some embodiments, the TX-UE determines whether to perform retransmission of the same TB and which TX beam(s) to use for the retransmission based on HARQ-ACK reports from the GC member UEs. For example, no retransmission of the same TB is performed by the TX-UE if at least one ACK is received from each of the RX-UEs (groupcast member UEs). In another example, when at least one of the RX-UEs (one of the groupcast member UEs) did not feedback an ACK, the TX-UE retransmit the same SL TB (e.g., with a different redundancy version) using at least one of the TX beams associated with/corresponding to the SL transmission for which a NACK is reported from the at least one of the RX-UEs. It is clear that if an ACK is already reported by a RX-UE, the TX-UE would not need to perform a retransmission of the same SL TB for the RX-UE even if the said RX-UE has also reported a NACK previously. By doing so, the number of retransmissions for the same SL TB using different TX beams (i.e., in different TX directions) would be minimized, since only the NACK reports from RX-UEs that have not successfully decoded the SL TB are considered for the retransmissions.

In reference to diagram 100 in FIG. 5, the proposed method of TX beam selection is exemplary illustrated on reducing the number of TX beams and SL transmissions in delivering a message TB for sidelink groupcast communication with ACK/NACK feedback enabled (groupcast option 2). In NR sidelink communication, when SL HARQ-ACK reporting is enabled in SCI, every transmission of a SL message TB always has a corresponding PSFCH occasion, and within which, one or more PSFCH resources are allocated/mapped for the SL HARQ-ACK reporting from the target/intended receiver UEs. Let's first assume there are 3 member UEs in a SL groupcast communication, and denote UE1 as the SL message TB transmitting UE, and UE2 and UE3 are the intended/target receiver UEs for the transmission and are required to send HARQ-ACK (ACK/NACK) feedback reports in an individually dedicated PSFCH resource when they receive each transmission of the message TB until an ACK has been reported individually.

In some embodiments, for the initial transmission of a SL TB1, without any prior knowledge of a best TX beam for each UE2 and UE3, the UE1 sweeps across a number of supported TX beams (#1, #2, #3, #4) in 4 different time slots 101, 102, 103, and 104, respectively. As mentioned previously, each SL transmission has its own PSFCH occasion. In this case, the PSFCH occasions in 107, 108, 109, and 110 are the four PSFCH occasions correspond to the initial transmissions of SL TB1 using the supported TX beams (#1, #2, #3, #4).

From both UE2 and UE3, the UEs individually send a HARQ-ACK report (ACK or NACK) every time it receives a SL transmission from UE1 until an ACK is sent. In this case, out of the 4 initial transmissions of SL TB1, UE2 reports a NACK in PSFCH occasion 107 and 108 due to decoding failures of the SL transmissions using TX Beam #1 101 and Beam #2 102. But UE2 can successfully decode the SL transmission using Beam #3 103 and hence it reports an ACK in the corresponding PSFCH occasion 109. As such, UE2 no longer need to provide any further HARQ-ACK report for the same SL TB1 even though it continues to receive SL (re)transmissions for the same SL TB1 in 104, 105 and 106. But out of the 4 initial transmissions of SL TB1 (101-104)), UE3 can not detect and receive the SL transmissions in 101 and 102 (e.g., due to TX Beam #1 and #2 are not in the direction towards UE3), and hence, no HARQ-ACK report from UE3 in PSFCH occasions 107 and 108.

For the 2 remaining initial transmissions of SL TB1 103 and 104 using Beam #3 and Beam #4, although UE3 can detect and perform decoding of these two transmissions, but the results are not successful and therefore UE3 reports a NACK result in the corresponding PSFCH occasions 109 and 110. For the SL TB1 transmitting UE1, based on the reported HARQ-ACK reports from both UE2 and UE3 for the 4 initial transmissions of SL TB1, according to the proposed TX beam selection example method 1, it is clear that the selection of TX beam(s) for the subsequent retransmission of SL TB1 does not need to take into account of HARQ-ACK reports from UE2 (since it has already reported an ACK in PSFCH occasion 109). Then the selection of TX beam by UE1 for the retransmission of SL TB1 would be reasonable to consider only the PSFCH occasions where UE3 has reported a NACK result 109 and 110. In this case, UE1 selects and uses TX Beam #3 and #4 for the retransmissions of SL TB1 in 105 and 106. From these 2 retransmissions, UE3 reports a NACK in the corresponding PSFCH occasion 111 and an ACK in PSFCH occasion 112, and UE1 no longer need to any further retransmission of SL TB1 after 106.

In summary, by taking into account of SL HARQ-ACK reports from receiver UEs in a SL groupcast communication, UE1 would only need to perform 2 retransmissions of SL TB1 using the proposed TX beam selection example method 1, instead of 4 retransmissions if UE1 blindly retransmits the same SL TB1 in all the supported beam directions.

### Example Method 2 (Retransmission of a SL TB Only in the Beam Direction Where NACK is Reported)

In some embodiments, in SL groupcast communication, when SL HARQ-ACK reporting is enabled and groupcast Option 1 is indicated by the SL transmitting UE (TX-UE) in sidelink control information (SCI) for a transmitted message TB, each intended target receiver UE (RX-UE) of the transmission (i.e., every UE within a communication distance range) is required to send only a NACK report to the TX-UE when the decoding result of the message TB received by the RX-UE is unsuccessful (failure), via a common PSFCH resource in a PSFCH occasion associated to the SL transmission.

In some embodiments, for an initial delivery of a SL message transport block (TB) in SL groupcast communication, the TX-UE performs multiple transmissions of the same TB (i.e., using a same HARQ redundancy version but in different time slots) using a set of TX beams supported by the TX-UE (e.g., in different beam directions by sweeping across the set of supported TX beams).

In some embodiments, for a SL message TB, a RX-UE reports a NACK if decoding of the message TB is a failure and the RX-UE has not successfully decoded the same TB in the past. In some examples, in groupcast Option 1 HARQ-ACK feedback scheme (NACK-only), each of the multiple transmissions of the same TB corresponds to only one PSFCH feedback resource which is common to all receiver UEs to report a NACK result when SL TB decoding is unsuccessful (failure). As such, the SL TB TX-UE cannot distinguish which receiver UE(s) has reported a NACK result, nor how many NACK results have reported, nor whether a particular RX-UE has eventually decoded the SL TB even though the RX-UE has previously reported a NACK for the same SL TB.

In some embodiments, the TX-UE performs retransmission of the same message TB using only the TX beam(s) corresponds to PSFCH occasion(s) of reported NACK(s) until no NACK is received or a maximum number of retransmissions for the said TB is reached. In some examples, the TX-UE does not perform a retransmission of the message TB using a TX beam that corresponds to a PSFCH occasion where no NACK report is detected by the TX-UE. As such, the number of TX beams and retransmissions are minimized in delivering the message TB to the intended target UEs within the communication distance range.

In reference to diagram 200 in FIG. 6, the proposed method of TX beam selection is exemplary illustrated to reduce the number of TX beams and SL transmissions in delivering a message TB for sidelink groupcast communication with NACK-only feedback enabled (groupcast option 1). In NR sidelink communication, when SL HARQ-ACK reporting is enabled in SCI, every transmission of a SL message TB always has a corresponding PSFCH occasion, and within which, one or more PSFCH resources are allocated/mapped for the SL HARQ-ACK reporting from the target/intended receiver UEs.

Let's first assume there is one UE transmitting a SL message TB that is intended for reception by all UEs within a communication distance range in a SL groupcast communication, and indicating groupcast option 1 as the SL HARQ-ACK feedback option in SCI. In the case of groupcast option 1 (NACK-only feedback), as mentioned previously, only one common PSFCH resource is allocated/mapped for the SL HARQ-ACK reporting from multiple receiver UEs in a PSFCH occasion. For the initial transmission of the SL message TB, without any prior knowledge of any location of the target receiver UEs within the communication distance range (which could be in any direction from the TX-UE), the TX-UE sweeps across a number of supported TX beams (#1, #2, #3, #4) in 4 different time slots 201, 202, 203, and 204, respectively. As mentioned previously, each SL transmission has its own PSFCH occasion. In this case, the PSFCH occasions in 207, 208, 209, and 210 are the four PSFCH occasions correspond to the initial transmissions of SL TB using the supported TX beams (#1, #2, #3, #4). Out of all the intended receiver UEs, a “NACK-only” HARQ-ACK report is sent from a receiver UE that failed to decode the SL TB every time it receives a SL transmission from the TX-UE until it has successfully decoded the SL TB. In this case, out of the 4 initial transmissions of the SL TB, the TX-UE detects at least one NACK is reported for the first initial transmission of the SL TB using TX Beam #1 201 in the common PSFCH resource for all UEs of the corresponding PSFCH occasion 207.

For the second initial transmission of the SL TB using TX Beam #2 (202), the TX-UE detects at least one NACK is reported in the corresponding PSFCH occasion 208. For the third and fourth initial transmissions of the SL TB using TX Beam #3 203 and Beam #4 204, the TX-UE detects no NACK is reported in the corresponding PSFCH occasions 209 and 210, respectively. This means, either there no target UE is located in the directions of Beam #3 and Beam #4, or all target UEs located in the directions of Beam #3 and Beam #4 have successfully decoded the SL TB. In both cases, clearly it is not necessary for the TX-UE to perform a retransmission of the same SL TB in these two directions anymore (using Beam #3 and #4). As such, the TX-UE performs retransmissions of the same SL TB using just Beam #1 205 and Beam #2 206 for which the NACK reports were received in 207 and 208 previously.

Assuming this time no more NACK report is received for the retransmissions of the same SL TB in the corresponding PSFCH occasions 211 and 212, the TX-UE may stop any further retransmission of the same SL TB. Overall, by taking into account of SL HARQ-ACK reports from receiver UEs in a SL groupcast communication, the TX-UE would only need to perform 2 retransmissions of SL TB using the proposed TX beam selection example method 2, instead of 4 retransmissions if the TX-UE blindly retransmits the same SL TB in all the supported beam directions.

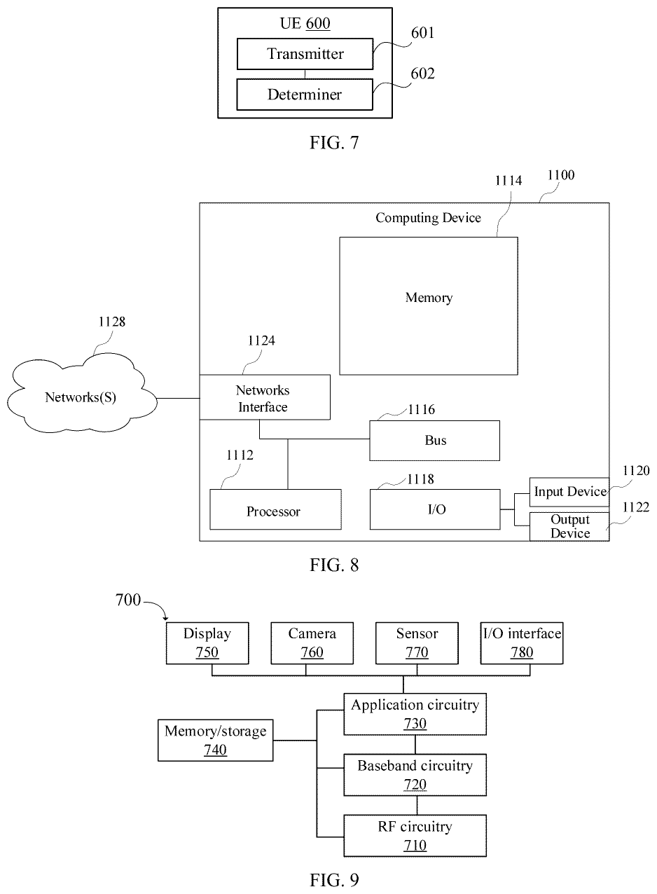

FIG. 7 illustrates a UE 600 for wireless communication according to an embodiment of the present disclosure. The UE 600 includes a transmitter 601 and a determiner 602. The transmitter 601 is configured to perform a plurality of initial transmissions of a sidelink message transport block (TB) using a plurality of transmit beams in a plurality of time slots, respectively, wherein the plurality of initial transmissions of the sidelink message TB are associated with a plurality of physical sidelink feedback channel (PSFCH) occasions, respectively. The determiner 602 is configured to use a transmit beam selection based on at least one hybrid automatic repeat and request-acknowledgement (HARQ-ACK) report from at least one HARQ-ACK feedback UE and at least one of the plurality of PSFCH occasions. This can solve issues in the prior art and other issues and/or improve SL communication performance and reliability.

In some embodiments, the plurality of initial transmissions of the sidelink message TB are performed in physical sidelink control channels (PSCCHs) and/or physical sidelink shared channels (PSSCHs). In some embodiments, the determiner 602 is further configured to determine whether to perform at least one retransmission of the sidelink message TB and determine at least one of the transmit beams for the at least one retransmission of the sidelink message TB based on the at least one HARQ-ACK report from the at least one HARQ-ACK feedback UE and the at least one PSFCH occasion.

In some embodiments, no retransmission of the sidelink message TB is performed by the transmitter if at least one ACK of the at least one HARQ-ACK report is received from the at least one HARQ-ACK feedback UE. In some embodiments, if the transmitter 601 does not receive at least one ACK of the at least one HARQ-ACK report from the at least one HARQ-ACK feedback UE, the at least one retransmission of the sidelink message TB is performed by the transmitter 601 using the at least one transmit beam corresponding to at least one NACK of the at least one HARQ-ACK report received from the at least one HARQ-ACK feedback UE.

In some embodiments, the at least one retransmission of the sidelink message TB is performed by the transmitter 601 using the at least one transmit beam corresponding to at least one NACK of the at least one HARQ-ACK report received from the at least one HARQ-ACK feedback UE until no NACK is received or a maximum number of retransmissions for the sidelink message TB is reached.

In some embodiments, the term “/” can be interpreted to indicate “and/or.” The term “configured” can refer to “pre-configured” and “network configured”. The term “pre-defined” or “pre-defined rules” in the present disclosure may be achieved by pre-storing corresponding codes, tables, or other manners for indicating relevant information in devices (e.g., including a UE and a network device). The specific implementation is not limited in the present disclosure. For example, “pre-defined” may refer to those defined in a protocol. It is also to be understood that in the disclosure, “protocol” may refer to a standard protocol in the field of communication, which may include, for example, an LTE protocol, NR protocol and relevant protocol applied in the future communication system, which is not limited in the present disclosure.

In summary, in order for a SL transmitter UE (TX-UE) to determine and select appropriate one or more TX beams for retransmission a SL message TB in a SL groupcast communication without the traditional CSI-RS transmission, measurement and beam index reporting from the receiver UEs, it is proposed to adopt a TX beam selection approach based on HARQ-ACK feedback information received in PSFCH occasion(s), and the TX-UE performs retransmission of the SL message TB using one or more TX beams that corresponds to received NACK report(s). Further, example method 1 for groupcast option 2 and unicast communication (ACK and NACK SL-HARQ reporting) and example method 2 for Groupcast option 1 (NACK-only SL-HARQ reporting) are disclosed.

Commercial interests for some embodiments are as follows. 1. Solving issues in the prior art and other issues. 2. Improving a sidelink (SL) communication performance. 3. Some embodiments of the present disclosure are used by 5G-NR chipset vendors, V2X communication system development vendors, automakers including cars, trains, trucks, buses, bicycles, moto-bikes, helmets, and etc., drones (unmanned aerial vehicles), smartphone makers, smart watches, wireless earbuds, wireless headphones, communication devices, remote control vehicles, and robots for public safety use, AR/VR device maker for example gaming, conference/seminar, education purposes, smart home appliances including TV, stereo, speakers, lights, door bells, locks, cameras, conferencing headsets, and etc., smart factory and warehouse equipment including IIoT devices, robots, robotic arms, and simply just between production machines. In some embodiments, commercial interest for the disclosed invention and business importance includes lowering power consumption for wireless communication means longer operating time for the device and/or better user experience and product satisfaction from longer operating time between battery charging. Some embodiments of the present disclosure are a combination of “techniques/processes” that can be adopted in 3GPP specification to create an end product. Some embodiments of the present disclosure relate to mobile cellular communication technology in 3GPP NR Releases 17, 18, 19, and beyond for providing direct device-to-device (D2D) wireless communication services.

FIG. 8 is a block diagram of an example of a computing device according to an embodiment of the present disclosure. Any suitable computing device can be used for performing the operations described herein. For example, FIG. 8 illustrates an example of the computing device 1100 that can implement some embodiments in FIG. 1 to FIG. 7, using any suitably configured hardware and/or software. In some embodiments, the computing device 1100 can include a processor 1112 that is communicatively coupled to a memory 1114 and that executes computer-executable program code and/or accesses information stored in the memory 1114. The processor 1112 may include a microprocessor, an application-specific integrated circuit (“ASIC”), a state machine, or other processing device. The processor 1112 can include any of a number of processing devices, including one. Such a processor can include or may be in communication with a computer-readable medium storing instructions that, when executed by the processor 1112, cause the processor to perform the operations described herein.

The memory 1114 can include any suitable non-transitory computer-readable medium. The computer-readable medium can include any electronic, optical, magnetic, or other storage device capable of providing a processor with computer-readable instructions or other program code. Non-limiting examples of a computer-readable medium include a magnetic disk, a memory chip, a read-only memory (ROM), a random access memory (RAM), an application specific integrated circuit (ASIC), a configured processor, optical storage, magnetic tape or other magnetic storage, or any other medium from which a computer processor can read instructions. The instructions may include processor-specific instructions generated by a compiler and/or an interpreter from code written in any suitable computer-programming language, including, for example, C, C++, C #, visual basic, java, python, perl, javascript, and actionscript.

The computing device 1100 can also include a bus 1116. The bus 1116 can communicatively couple one or more components of the computing device 1100. The computing device 1100 can also include a number of external or internal devices such as input or output devices. For example, the computing device 1100 is illustrated with an input/output (“I/O”) interface 1118 that can receive input from one or more input devices 1120 or provide output to one or more output devices 1122. The one or more input devices 1120 and one or more output devices 1122 can be communicatively coupled to the I/O interface 1118. The communicative coupling can be implemented via any suitable manner (e.g., a connection via a printed circuit board, connection via a cable, communication via wireless transmissions, etc.). Non-limiting examples of input devices 1120 include a touch screen (e g., one or more cameras for imaging a touch area or pressure sensors for detecting pressure changes caused by a touch), a mouse, a keyboard, or any other device that can be used to generate input events in response to physical actions by a user of a computing device. Non-limiting examples of output devices 1122 include a liquid crystal display (LCD) screen, an external monitor, a speaker, or any other device that can be used to display or otherwise present outputs generated by a computing device.

The computing device 1100 can execute program code that configures the processor 1112 to perform one or more of the operations described above with respect to FIG. 1 to FIG. 7. The program code may be resident in the memory 1114 or any suitable computer-readable medium and may be executed by the processor 1112 or any other suitable processor.

The computing device 1100 can also include at least one network interface device 1124. The network interface device 1124 can include any device or group of devices suitable for establishing a wired or wireless data connection to one or more data networks 1128. Non limiting examples of the network interface device 1124 include an Ethernet network adapter, a modem, and/or the like. The computing device 1100 can transmit messages as electronic or optical signals via the network interface device 1124.

FIG. 9 is a block diagram of an example system 700 for wireless communication according to an embodiment of the present disclosure. Embodiments described herein may be implemented into the system using any suitably configured hardware and/or software. FIG. 9 illustrates the system 700 including a radio frequency (RF) circuitry 710, a baseband circuitry 720, an application circuitry 730, a memory/storage 740, a display 750, a camera 760, a sensor 770, and an input/output (I/O) interface 780, coupled with each other at least as illustrated.

The application circuitry 730 may include a circuitry such as, but not limited to, one or more single-core or multi-core processors. The processors may include any combination of general-purpose processors and dedicated processors, such as graphics processors, application processors. The processors may be coupled with the memory/storage and configured to execute instructions stored in the memory/storage to enable various applications and/or operating systems running on the system.

The baseband circuitry 720 may include circuitry such as, but not limited to, one or more single-core or multi-core processors. The processors may include a baseband processor. The baseband circuitry may handle various radio control functions that enables communication with one or more radio networks via the RF circuitry. The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry.

In various embodiments, the baseband circuitry 720 may include circuitry to operate with signals that are not strictly considered as being in a baseband frequency. For example, in some embodiments, baseband circuitry may include circuitry to operate with signals having an intermediate frequency, which is between a baseband frequency and a radio frequency.

The RF circuitry 710 may enable communication with wireless networks using modulated electromagnetic radiation through a non-solid medium. In various embodiments, the RF circuitry may include switches, filters, amplifiers, etc. to facilitate the communication with the wireless network.

In various embodiments, the RF circuitry 710 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to the user equipment, eNB, or gNB may be embodied in whole or in part in one or more of the RF circuitry, the baseband circuitry, and/or the application circuitry. As used herein, “circuitry” may refer to, be part of, or include an application specific integrated circuit (ASIC), an electronic circuit, a processor (shared, dedicated, or group), and/or a memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules.

In some embodiments, some or all of the constituent components of the baseband circuitry, the application circuitry, and/or the memory/storage may be implemented together on a system on a chip (SOC).

The memory/storage 740 may be used to load and store data and/or instructions, for example, for system. The memory/storage for one embodiment may include any combination of suitable volatile memory, such as dynamic random access memory (DRAM)), and/or non-volatile memory, such as flash memory.

In various embodiments, the I/O interface 780 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface.

In various embodiments, the sensor 770 may include one or more sensing devices to determine environmental conditions and/or location information related to the system. In some embodiments, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite.

In various embodiments, the display 750 may include a display, such as a liquid crystal display and a touch screen display. In various embodiments, the system 700 may be a mobile computing device such as, but not limited to, a laptop computing device, a tablet computing device, a netbook, an ultrabook, a smartphone, a AR/VR glasses, etc. In various embodiments, system may have more or less components, and/or different architectures. Where appropriate, methods described herein may be implemented as a computer program. The computer program may be stored on a storage medium, such as a non-transitory storage medium.

A person having ordinary skill in the art understands that each of the units, algorithm, and steps described and disclosed in the embodiments of the present disclosure are realized using electronic hardware or combinations of software for computers and electronic hardware. Whether the functions run in hardware or software depends on the condition of application and design requirement for a technical plan.

A person having ordinary skill in the art can use different ways to realize the function for each specific application while such realizations cannot go beyond the scope of the present disclosure. It is understood by a person having ordinary skill in the art that he/she can refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure can be realized with other ways. The above-mentioned embodiments are exemplary only. The division of the units is merely based on logical functions while other divisions exist in realization. It is possible that a plurality of units or components are combined or integrated in another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments can be integrated in one processing unit, physically independent, or integrated in one processing unit with two or more than two units.

If the software function unit is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

What is claimed is:

1. A method of beam determination in sidelink groupcast communication (GC) by a user equipment (UE), comprising:
performing a plurality of initial transmissions of a sidelink message transport block (TB) using a plurality of transmit beams in a plurality of time slots, respectively, wherein the plurality of initial transmissions of the sidelink message TB are associated with a plurality of physical sidelink feedback channel (PSFCH) occasions, respectively; and
using a transmit beam selection based on at least one hybrid automatic repeat and request-acknowledgement (HARQ-ACK) report from at least one HARQ-ACK feedback UE and at least one of the plurality of PSFCH occasions.

2. The method of claim 1, wherein the plurality of initial transmissions of the sidelink message TB are performed in physical sidelink control channels (PSCCHs) and/or physical sidelink shared channels (PSSCHs).

3. The method of claim 1, wherein the transmit beam selection comprises determining whether to perform at least one retransmission of the sidelink message TB and determining at least one of the transmit beams for the at least one retransmission of the sidelink message TB based on the at least one HARQ-ACK report from the at least one HARQ-ACK feedback UE and the at least one PSFCH occasion.

4. The method of claim 3, wherein no retransmission of the sidelink message TB is performed by the UE if at least one ACK of the at least one HARQ-ACK report is received from the at least one HARQ-ACK feedback UE.

5. The method of claim 3, wherein if the UE does not receive at least one ACK of the at least one HARQ-ACK report from the at least one HARQ-ACK feedback UE, the at least one retransmission of the sidelink message TB is performed by the UE using the at least one transmit beam corresponding to at least one NACK of the at least one HARQ-ACK report received from the at least one HARQ-ACK feedback UE.

6. The method of claim 3, wherein the at least one retransmission of the sidelink message TB is performed by the UE using the at least one transmit beam corresponding to at least one NACK of the at least one HARQ-ACK report received from the at least one HARQ-ACK feedback UE until no NACK is received or a maximum number of retransmissions for the sidelink message TB is reached.

7. A user equipment (UE), comprising:
a memory;
a transceiver; and
a processor coupled to the memory and the transceiver;
wherein the transceiver is configured to perform a plurality of initial transmissions of a sidelink message transport block (TB) using a plurality of transmit beams in a plurality of time slots, respectively, wherein the plurality of initial transmissions of the sidelink message TB are associated with a plurality of physical sidelink feedback channel (PSFCH) occasions, respectively; and
wherein the processor is configured to use a transmit beam selection based on at least one hybrid automatic repeat and request-acknowledgement (HARQ-ACK) report from at least one HARQ-ACK feedback UE and at least one of the plurality of PSFCH occasions.

8. The UE of claim 7, wherein the plurality of initial transmissions of the sidelink message TB are performed in physical sidelink control channels (PSCCHs) and/or physical sidelink shared channels (PSSCHs).

9. The UE of claim 7, wherein the processor is further configured to determine whether to perform at least one retransmission of the sidelink message TB and determine at least one of the transmit beams for the at least one retransmission of the sidelink message TB based on the at least one HARQ-ACK report from the at least one HARQ-ACK feedback UE and the at least one PSFCH occasion.

10. The UE of claim 9, wherein no retransmission of the sidelink message TB is performed by the transceiver if at least one ACK of the at least one HARQ-ACK report is received from the at least one HARQ-ACK feedback UE.

11. The UE of claim 9, wherein if the transceiver does not receive at least one ACK of the at least one HARQ-ACK report from the at least one HARQ-ACK feedback UE, the at least one retransmission of the sidelink message TB is performed by the transceiver using the at least one transmit beam corresponding to at least one NACK of the at least one HARQ-ACK report received from the at least one HARQ-ACK feedback UE.

12. The UE of claim 9, wherein the at least one retransmission of the sidelink message TB is performed by the transceiver using the at least one transmit beam corresponding to at least one NACK of the at least one HARQ-ACK report received from the at least one HARQ-ACK feedback UE until no NACK is received or a maximum number of retransmissions for the sidelink message TB is reached.

13. A chip, comprising:
a processor, configured to call and run a computer program stored in a memory, to cause a device in which the chip is installed to:
perform a plurality of initial transmissions of a sidelink message transport block (TB) using a plurality of transmit beams in a plurality of time slots, respectively, wherein the plurality of initial transmissions of the sidelink message TB are associated with a plurality of physical sidelink feedback channel (PSFCH) occasions, respectively; and
use a transmit beam selection based on at least one hybrid automatic repeat and request-acknowledgement (HARQ-ACK) report from at least one HARQ-ACK feedback UE and at least one of the plurality of PSFCH occasions.

14. The chip of claim 13, wherein the plurality of initial transmissions of the sidelink message TB are performed in physical sidelink control channels (PSCCHs) and/or physical sidelink shared channels (PSSCHs).

15. The chip of claim 13, wherein the device is further caused to determine whether to perform at least one retransmission of the sidelink message TB and determine at least one of the transmit beams for the at least one retransmission of the sidelink message TB based on the at least one HARQ-ACK report from the at least one HARQ-ACK feedback UE and the at least one PSFCH occasion.

16. The chip of claim 15, wherein no retransmission of the sidelink message TB is performed by the device if at least one ACK of the at least one HARQ-ACK report is received from the at least one HARQ-ACK feedback UE.

17. The chip of claim 15, wherein if the device does not receive at least one ACK of the at least one HARQ-ACK report from the at least one HARQ-ACK feedback UE, the at least one retransmission of the sidelink message TB is performed by the device using the at least one transmit beam corresponding to at least one NACK of the at least one HARQ-ACK report received from the at least one HARQ-ACK feedback UE.

18. The chip of claim 15, wherein the at least one retransmission of the sidelink message TB is performed by the device using the at least one transmit beam corresponding to at least one NACK of the at least one HARQ-ACK report received from the at least one HARQ-ACK feedback UE until no NACK is received or a maximum number of retransmissions for the sidelink message TB is reached.
